(19) United States
(12) Patent Application Publication
(10) Pub. No.: US 2025/0153076 A1
(43) Pub. Date: May 15, 2025

(54) FILTER APPARATUS AND FILTERING METHOD

(71) Applicant: Steve C. Benesi, Novato, CA (US)

(72) Inventor: Steve C. Benesi, Novato, CA (US)

(21) Appl. No.: 18/715,370

(22) PCT Filed: Nov. 22, 2022
(86) PCT No.: PCT/US2022/050663

§ 371 Date: May 31, 2024

Related U.S. Application Data
(60) Provisional application No. 63/285,272, filed on Dec. 2, 2021.

(51) Int. Cl. B01D 25/127; B01D 25/19; B01D 25/28; B01D 25/34

(52) U.S. Cl. CPC B01D 25/127; B01D 25/19; B01D 25/284; B01D 25/343

(57) ABSTRACT

A filtration apparatus that can include a filtering device can be configured as a pressure filter. The filter device can facilitate rapid cycling of cake discharge so that the cake formation and discharge sequence can complete itself in a short period of time (e.g. a few seconds, no more than 30 seconds, no more than 10 seconds, up to 18 seconds, less than a minute, less than 3 minutes, etc.).

### CROSS-REFERENCE TO RELATED APPLICATIONS

The present application claims priority to U.S. Provisional Patent Application No. 63/285,272, filed on Dec. 2, 2021.

### FIELD

The present innovation is directed to filtration systems, filter devices, and methods of making and using the same.

### BACKGROUND

Filter devices are often used in mineral processing, processing of starch or chemical products, processing of agglomerated material, power generation applications, and other industries to remove solid materials from a slurry (e.g. a liquid having solid particulates entrained therein or a gas having solid particulates entrained therein). Examples of such devices can be appreciated from U.S. Pat. Nos. 6,409,929, 6,006,554, 4,330,405, 4,207,190, 4,152,267, 3,869,389, 3,471,026, 3,291,312, 3,250,396, and 1,538,980 and U.S. Patent Application Publication Nos. 2018/0326357, 2018/0071667, 2017/0341004, 2016/0121245, 2016/0074784, 2015/0266780, 2015/0184099, 2014/0346104, 2013/0161252, 2013/0008006, 2011/0131873, 2011/0011785, 2010/0115899, 2009/0139193, 2008/0314012, 2007/0017196, 2005/0067342, and 2004/0177471. Other examples of filter devices and mechanisms that can be used in such devices can be appreciated from my International Publication No. WO 2020/185484, my U.S. Pat. Nos. 7,011,741, 6,521,135, 6,491,817, 6,159,359, 5,477,891, 5,292,434, 5,059,318, and U.S. Patent Application Publication Nos. 2006/0102545, 2006/0027509, 2006/0283785, and 2007/0256984.

### SUMMARY

A filter apparatus, filtering method, filtering device, and methods of making and using the same are provided to provide improved filtering operation to separate particular material from a liquid that is within a slurry fed to different openable chambers of the device. Embodiments can be configured to facilitate the feeding of slurry into chambers while plates defining the chambers are in a closed position such that liquid from the slurry passes out of the chambers while solid particulates within the slurry are retained in the chambers via filter media positioned in the chambers. Once filter cakes are formed in the chambers, the plates can be moved to space the plates further away from each other to open the chambers. The filter cakes formed in the chambers can then be removed from the filter media and fed to a chute or other conduit for further processing of the separated solid particulates of the filter cakes. The plates can then be moved back towards each other so they are in their closed positions for defining the chambers and slurry can then be fed into the chambers for formation of additional filter cakes. Embodiments can be configured to permit formed filter cakes to be washed and dried prior to the opening of the chambers for outputting of the filter cakes. Embodiments can be configured to permit this filtering process to occur automatically so that filter cakes are formed, washed, dried, and output quickly in a filter cake formation, washing, drying, and output cycle of a pre-selected period of time that can be defined to be very short (e.g. less than 3 minutes and greater than 0 seconds, less than 1 minute and greater than 0 seconds, less than 30 seconds and greater than 0 seconds, less than 10 seconds and greater than 0 seconds, etc.). Some embodiments of the filtering device can be configured as a pressure filter.

In a first aspect, a filtration apparatus is provided. The filtration apparatus can include a base and a filtering device supported by the base. The filtering device can be adjustable between an open position and a closed position. The filtering device can have a plurality of filter cake generating modules. Each of the filter cake generating modules can include at least one moveable plate. The moveable plates of the filter cake generating modules can be moveable to be spaced apart from each other when the filtering device is in the open position and also be moveable to be positioned so that each of the plates is positioned adjacent to or in contact with at least one immediately adjacent other plate of another one of the filter cake generating modules when the filtering device is in the closed position. Each of the filter cake generating modules can have a first chamber when the filtering device is in the closed position. A plurality of filter media can also be provided (e.g. sheets of filter media, etc.). Each of the filter media can be positionable in a respective one of the first chambers to separate solid particulates of a slurry from a fluid of the slurry to form a filter cake. The apparatus can also include a filter device adjustment mechanism positioned to drive motion of the filter cake generating modules so the plates of the filter cake generating modules move away from each other to be spaced apart from each other when the filtering device is in the open position and also drive motion of the filter cake generating modules so the plates of the filter cake generating modules moved to be positioned adjacent to immediately adjacent ones of the plates of the filter cake generating modules when the filtering device is in the closed position.

In some implementations, the filter device adjustment mechanism can be positioned below the moveable plates and/or filter cake generating modules (e.g. below all of the filter cake generating modules and below all the plates) . . . . In other implementations, the filter device adjustment mechanism can be positioned above the moveable plates and/or filter cake generating modules (e.g. above all of the filter cake generating modules and also above all the plates).

In some implementations, the moveable plates of the filter cake generating modules can include first, second, and third filter cake generating modules. There can also be more filter cake generating modules as well. The plates can include a first plate, a second plate, a third plate, a fourth plate, a fifth plate and a sixth plate. The plates can be arranged so that the second plate is between the first plate and the third plate, the fourth plate is between the third plate and the fifth plate, and the fifth plate is between the fourth plate and the sixth plate. The first and second plates can be moved into contact with each other when the filtering device is in the closed position to form the first chamber of the first filter cake generating module. The third and fourth plates can be moved into contact with each other when the filtering device is in the closed position to form the first chamber of the second filter cake generating module. The fifth and sixth plates can also be moved into contact with each other when the filtering device is in the closed position to form the first chamber of the third filter cake generating module. Moreover, the second and third plates can be in contact with each other when the filtering device is in the closed position, the third and fourth plates can be in contact with each other when the filtering device is in the closed position, and the fourth and fifth plates can be in contact with each other when the filtering device is in the closed position. The plates can all be separated from each other to open the first chambers of the filter cake generating modules when the filtering device is in the open position.

In other implementations, the moveable plates of the filter cake generating modules can include first, second, and third filter cake generating modules. There can also be more filter cake generating modules as well. The plates can include a first plate, a second plate, a third plate, a fourth plate, and a fifth plate. The plates can be arranged so that the second plate is between the first plate and the third plate, and the fourth plate is between the third plate and the fifth plate. The first and second plates can be moved into contact with each other when the filtering device is in the closed position to form the first chamber of a first filter cake generating module. The second and third plates can be moved into contact with each other when the filtering device is in the closed position to form the first chamber of the second filter cake generating module. The fourth and fifth plates can also be moved into contact with each other when the filtering device is in the closed position to form the first chamber of the third filter cake generating module. The plates can also all be separated from each other to open the first chambers of the filter cake generating modules when the filtering device is in the open position.

In a second aspect, the filter device adjustment mechanism can include at least one scissor jack, at least one cylinder, or at least one linear actuator. For instance, the filter device adjustment mechanism can include at least one hydraulic cylinder, at least one pneumatic jack, at least one electric jack, at least one linear actuator, or an array of linear actuators.

In a third aspect, the filtering apparatus can include a feed device positioned to feed slurry into the first chambers of the filter cake generating modules while the filtering device is in the closed position. In some implementations, the feed device can also be configured to pass a drying fluid and/or a washing fluid into the filter cake generating modules while the filtering device is in the closed position. In some implementations the washing fluid can include at least one liquid (e.g. liquid water, etc.) and/or the drying fluid can include at least one gas.

In a fourth aspect, the filtering apparatus can include a plurality of intake pulleys and a plurality of discharge pulleys. A respective one of the intake pulleys can be positioned adjacent a first side of the plate of a respective one of the filter cake generating modules and a respective one of the discharge pulleys positioned adjacent a second side of the plate of the respective one of the filter cake generating modules adjacent a second side of the plate that is opposite the first side of the plate. The filter media can be being positionable in the respective one of the first chambers extending between the intake pulley and the discharge pulley.

In a fifth aspect, the filtering apparatus can include a filter media actuation device configured to move the plurality of filter media along the intake pulleys and the discharge pulleys to move the filter media to transport solid particulates of a filter cake formed on the filter media to a discharge conduit positioned adjacent to the discharge pulley adjacent to the second sides of the moveable plates of the filter cake generating modules when the filtering device is in the open position. The filter media can be comprised of a cloth material, polymeric material, elastomeric material, composite material, metallic material, ceramic material, other material and combinations thereof.

In a sixth aspect, the filtering apparatus can be provided so that each of the filter cake generating modules can include a pan positioned to support the filter media positionable within the first chamber. The pan can be convex to facilitate the filter media bowing or flexing when slurry is passed through the filter cake generating module and the filter media filters solid particulates from fluid of the slurry so the solid particulates accumulate on the filter media to form a filter cake.

In a seventh aspect, the filtering apparatus can be provided so that each of the filter cake generating modules can include a drainage grid and/or a distributor to facilitate the flow and distribution of slurry passed through the filter cake generating modules.

In an eighth aspect, the first aspect of the filtering apparatus can include any or all of the second through seventh aspects as well as additional features. For example, the first aspect can include one or more features of any combination of the second aspect, third aspect, fourth aspect, fifth aspect, sixth aspect or seventh aspect discussed above.

In a ninth aspect, a method of filtering particulate material from a slurry is provided. Embodiments of the method can utilize an embodiment of an above discussed filtering apparatus or another type of filtering apparatus embodiments. Embodiments of the method can include adjusting a filtering device of a filtering apparatus to move the filtering device to a closed position to close filter cake generating modules under sufficient pressure to offset filter chamber separating pressure from at least one influent fed into first chambers of the filter cake generating modules. The at least one influent can include a slurry (e.g. a fluid having solid particulates mixed therein, a liquid having solid particulates mixed therein, a gas flow having solid particulates mixed therein, etc.). The method can also include feeding the slurry into the first chambers while the filter cake generating modules are in their closed positions until the first chambers are filled to form filter cakes therein, passing washing fluid into the filled first chambers to wash the formed filter cakes within the first chambers, passing at least one gas into the first chambers to remove residual moisture from the filter cakes after the passing of the washing fluid into the filled first chambers to remove residual moisture from the filter cakes after they have been washed, adjusting the filter device to an open position to open the first chambers of the filter cake generating modules, and removing the filter cakes from the filter cake generating modules via a media advance system and positioning filter media within the first chamber of the filter cake generating modules while the filtering device is in the open position for use in a subsequent filter cake generation cycle.

In a tenth aspect, the method of filtering particulate material from a slurry can include passing the slurry along distributors of the filter cake generating modules while the feeding the slurry into the first chambers occurs.

In an eleventh aspect, the method of filtering particulate material from a slurry can include bowing or flexing filter media within the first chambers while the feeding of the slurry into the first chambers occurs while the filter cake generating modules are in their closed positions to form filter cakes on the filter media.

In a twelfth aspect, the method of filtering particulate material from a slurry, the removing of the filter cakes from the filter cake generating modules via a media advance system and positioning filter media within the first chamber of the filter cake generating modules while the filtering device is in the open position for use in a subsequent filter cake generation cycle can include moving the filter media along discharge pulleys positioned on second sides of the filter cake generating modules and intake pulleys positioned on first sides of the filter cake generating modules that are opposite the second sides via the media advance system. The media advance system can include a filter media actuation device. An example of such a device can be at least one motor positioned and connected to the filter media to drive motion of the filter media along the pulleys.

In a thirteenth aspect, the washing fluid can include at least one liquid (e.g. liquid water, etc.). A drying fluid can include at least one gas.

In a fourteenth aspect, the method of filtering particulate material from a slurry can include passing the slurry through distributor holes of plates of the filter cake generating modules while the feeding the slurry into the first chambers occurs.

In a fifteenth aspect, the method of filtering particulate material from a slurry can be implemented so that the adjusting of the filtering device of the filtering apparatus to move the filtering device to the closed position to close filter cake generating modules, the feeding of the slurry into the first chambers while the filter cake generating modules are in their closed positions until the first chambers are filled to form filter cakes therein; the passing of the washing fluid into the filled first chambers to wash the formed filter cakes within the first chambers, the passing of the at least one gas into the first chambers to remove residual moisture from the filter cakes after the passing of the washing fluid into the filled first chambers to remove residual moisture from the filter cakes after they have been washed, the adjusting the filter device to an open position to open the first chambers of the filter cake generating modules; and the removing of the filter cakes from the filter cake generating modules via the media advance system and positioning filter media within the first chamber of the filter cake generating modules while the filtering device is in the open position for use in a subsequent filter cake generation cycle; is performed in a filter cake generation cycle. The filter cake generation cycle can be performed in a pre-selected period of time that is less than 3 minutes and greater than 0 seconds, less than 1 minute and greater than 0 seconds, less than 30 seconds and greater than 0 seconds, or less than 10 seconds and greater than 0 seconds.

In a sixteenth aspect, embodiments of the method of filtering particulate material from a slurry of the ninth aspect can include one or more features of any or all of the tenth aspect, eleventh aspect, twelfth aspect, thirteenth aspect, fourteenth aspect, of fifteenth aspect. It should therefore be appreciated that the above aspects can be incorporated together in various ways to form additional embodiments. Examples of such embodiments include the below discussed embodiments as well as the exemplary embodiments shown in the drawings.

These and other objects, aspects and advantages of the present invention will be better appreciated in view of the drawings and following detailed description of certain exemplary embodiments thereof.

### BRIEF DESCRIPTION OF THE DRAWINGS

Exemplary embodiments of filtering devices, filtration apparatuses, and embodiments of methods for making and using the same are shown in the accompanying drawings. It should be understood that like reference numbers used in the drawings may identify like components.

FIG. 1 is a perspective view of a first exemplary embodiment of a filtering device.

FIG. 2 is a perspective view of an exemplary scissor lift jack that can be included in the first exemplary embodiment of the filtering device. It should be appreciated that other scissor lift jack embodiments can also be utilized, including simpler designs having simpler scissor lift frame arrangements.

FIG. 3 is a flow chart illustrating a first exemplary method of filtering particulate material from a slurry. It should be appreciated that the use of the washing fluid shown in FIG. 3 is an optional step of this exemplary method and that other embodiments may not utilize this step. Use of purge gas(es) shown in FIG. 3 may also be optional and other embodiments may not utilize this step. In yet other embodiments, the use of purge gas(es) and the use of the washing fluid as shown in FIG. 3 may not be utilized.

FIG. 4 is a schematic side elevational view of the first exemplary embodiment of the filtering device illustrating definable chambers for forming filter cakes therein.

FIG. 5 is a schematic end view of the first exemplary embodiment of the filtering device illustrating definable chambers for forming filter cakes therein.

FIG. 6 is a schematic view of an exemplary inlet section of a first chamber for forming a filter cake therein of the first exemplary embodiment of the filtering device when plates of the device are moved to their closed position for forming of filter cakes in chambers defined between adjacent plates.

FIG. 7 is an enlarged bottom view of a portion of the exemplary inlet section shown in FIG. 6 that is inside the broken line circle illustrated in FIG. 6.

FIG. 8 is top plan schematic view of the exemplary inlet section shown in FIG. 6 with the filter media, and other components removed to better illustrate slurry flow within the chamber from the inlet towards a fluid drainage outlet.

FIG. 9 is a schematic view of an exemplary outlet section of the first chamber for forming the filter cake therein of the first exemplary embodiment of the filtering device when plates of the device are moved to their closed position for forming of filter cakes in chambers defined between adjacent plates.

FIG. 10 is a side view of an exemplary outlet portion that can be included in the exemplary outlet section shown in FIG. 9 within the broken line circle illustrated in FIG. 9.

FIG. 11 is a fragmentary schematic view of the exemplary outlet section shown in FIG. 9 illustrating an enlarged side view of the outlet.

FIG. 12 is a schematic sectional view illustrating a pulley and filter media arrangement that can be utilized for the discharge pulleys and the feed pulleys to manipulate filter media positionable in the first chamber between upper and lower plates that define the chamber for a filter cake generating module of the first exemplary embodiment of the filtering device.

FIG. 13 is schematic view of another exemplary embodiment of the filtering device.

FIG. 14 is a perspective view of another exemplary embodiment of the filtering device.

FIG. 15 is a schematic view of an exemplary inlet section of a first chamber for forming a filter cake therein of the first exemplary embodiment of the filtering device having an inverted plate configuration so that a filter cake is formable within the first chamber when plates of the device are moved to their closed position for forming the filter cake in the first chamber defined between adjacent plates.

FIG. 16 is a schematic view of an exemplary first chamber having filter media positioned therein in an open position for illustrating an exemplary filtration area for filter cake formation.

FIG. 17 is a schematic top view of an exemplary embodiment of the filtering device configured to have multiple columns and rows of plates for defining columns and rows of chambers for filter cake formation and discharge.

### DETAILED DESCRIPTION OF EXEMPLARY EMBODIMENTS

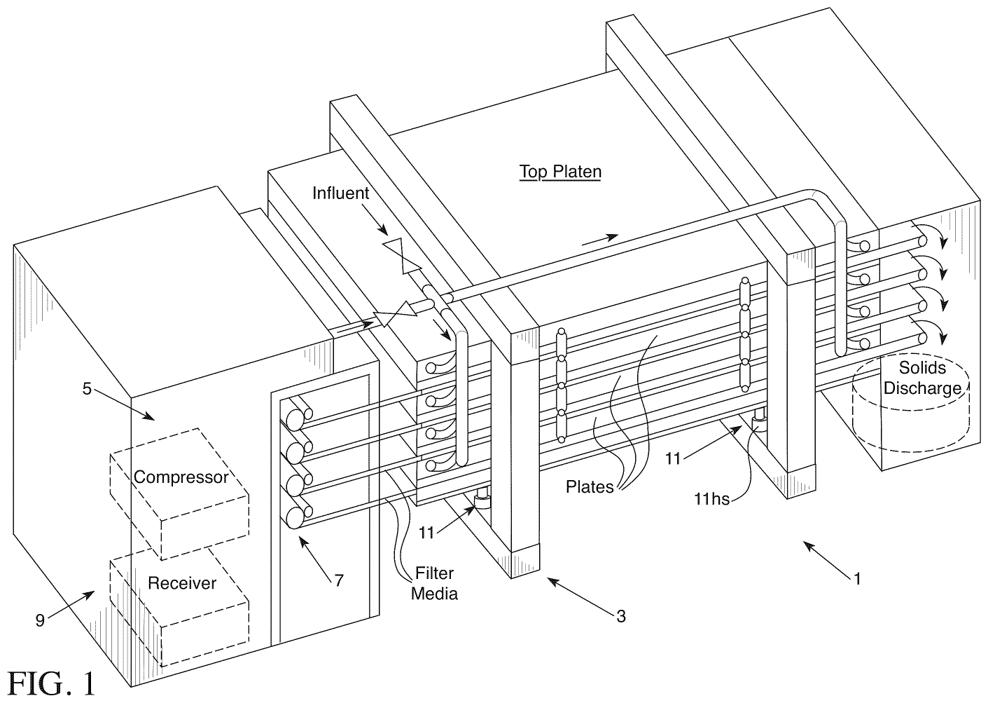

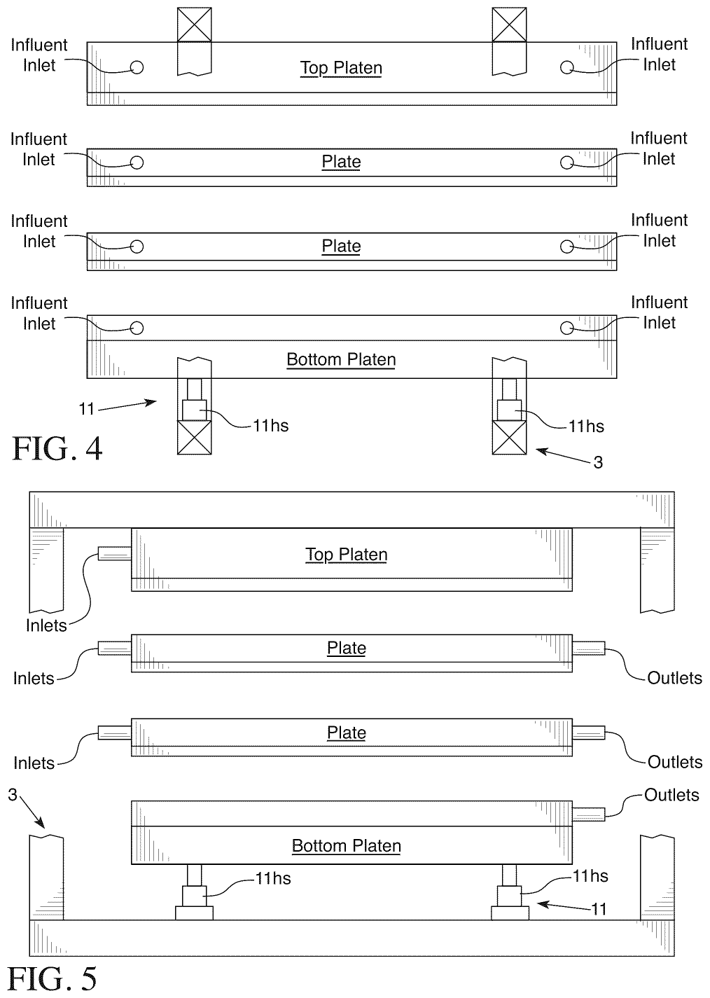

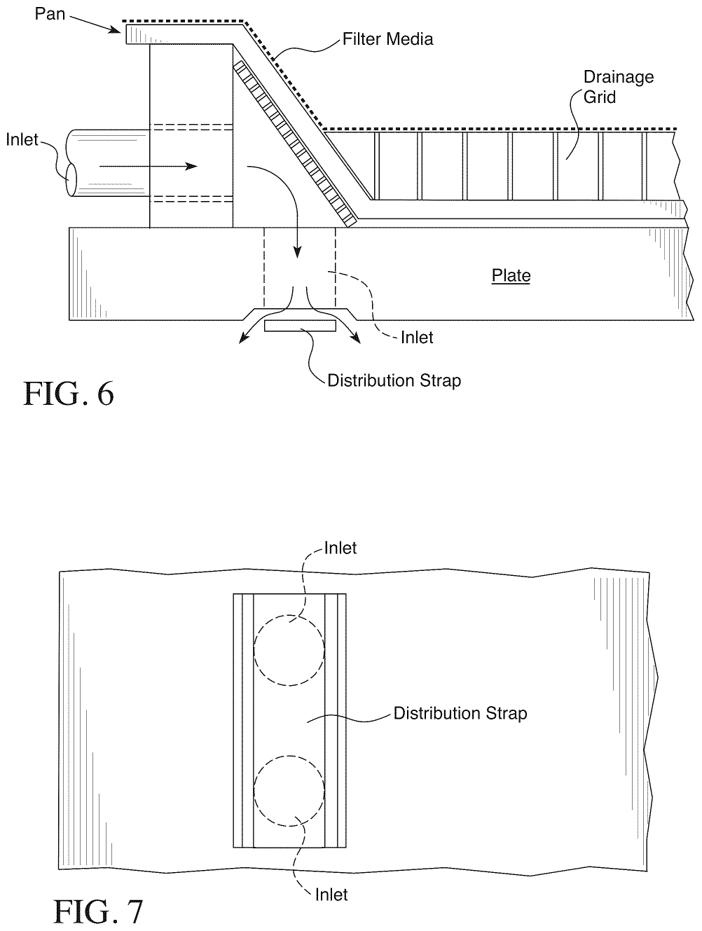

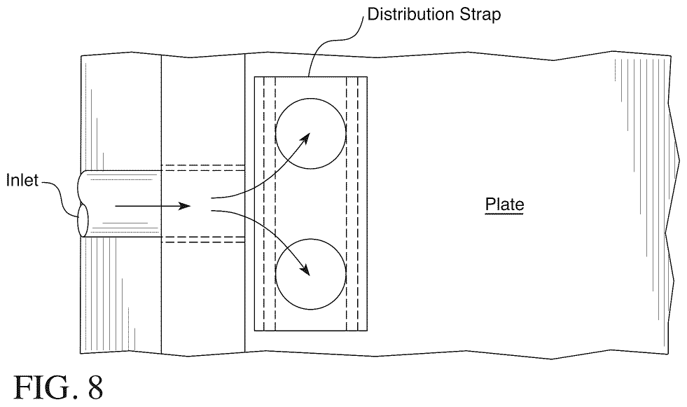

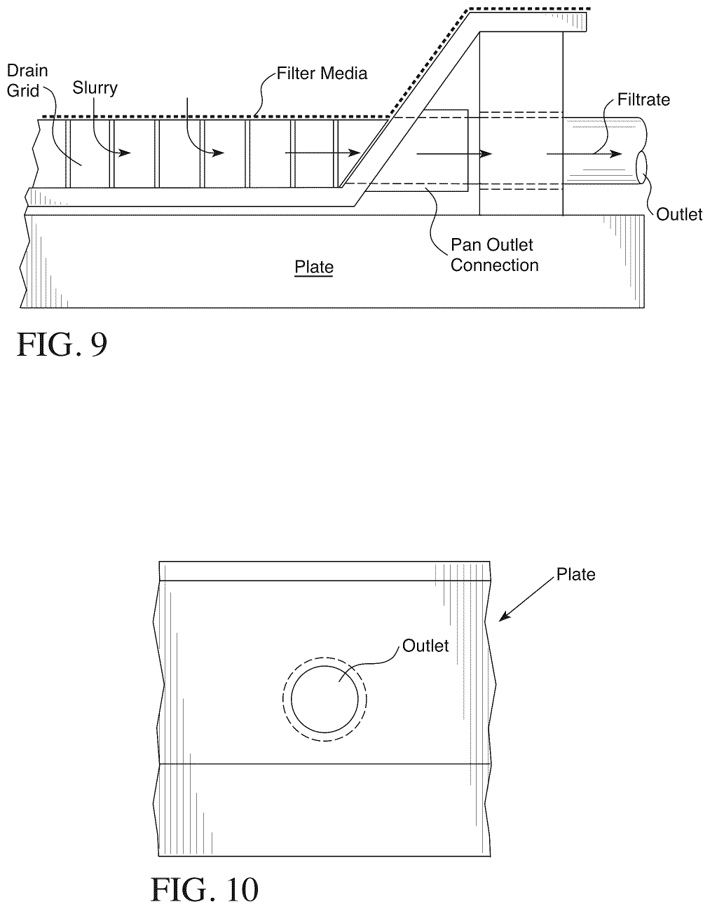

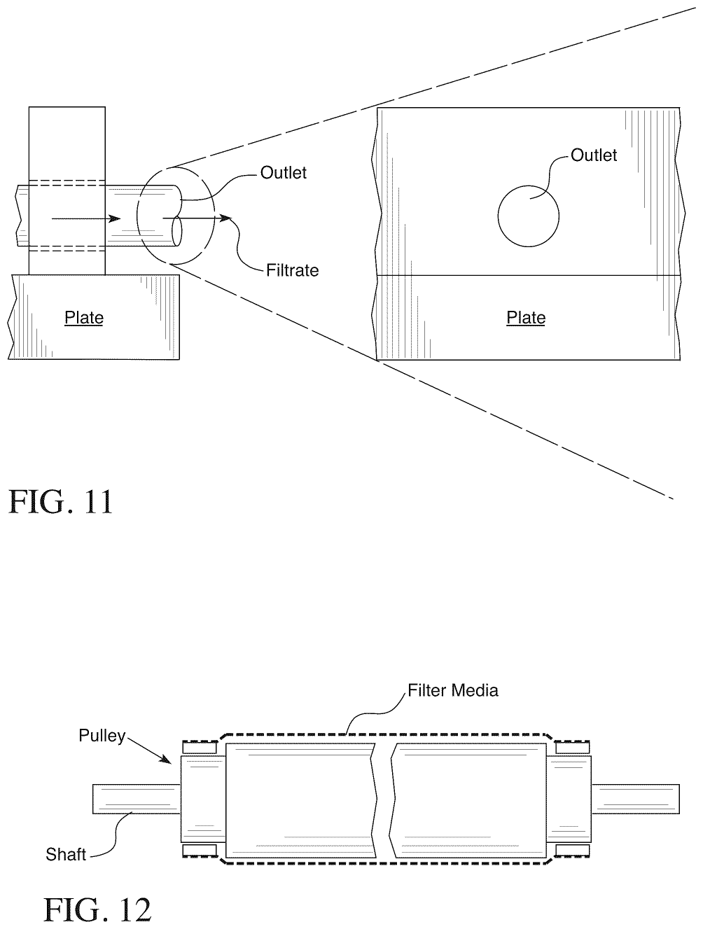

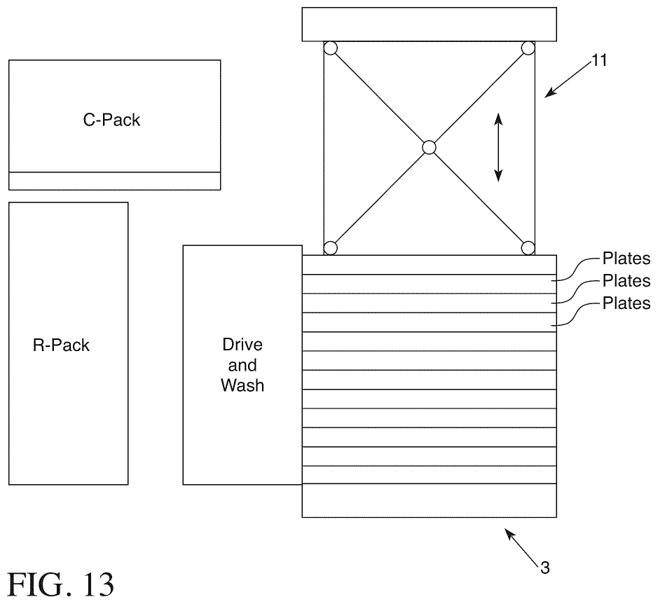

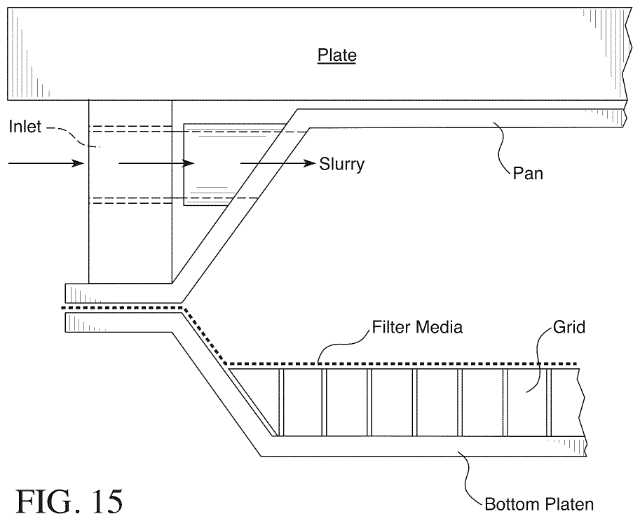

Referring to FIGS. 1-17, a filtration apparatus 1 can include a base 3, a pressurization mechanism 5 for maintaining the device 1 in a closed position when a slurry, washing fluid, or drying fluid is fed into chambers of the device, a filter media actuation device 7 for adjustable positioning of filter media and a feed device 9 for feeding slurry material having particulates entrained within a fluid (e.g. liquid or gas) as well as feeding a washing fluid and/or a drying fluid to chambers of a filtering device when the filtering device is in its closed position for forming filter cakes comprised of the solid particulate material separated from the fluid passed through the device for filtering the solid material form the fluid (e.g. liquid or gas).

Each first chamber defined when the filtering device is in its closed position can be a chamber defined by a filter cake generating module. Each of these modules can include a set of one or more plates (or platens). In some configurations, a platen (e.g. top platen) can refer to a top-most plate and a platen (e.g. bottom platen) can refer to a bottom-most plate while the terms “plate” or “plates” can refer to the plates arranged between the top platen and the bottom platen. The top platen, bottom platen, and plates between the top and bottom platens can be collectively referred to as “the plates” or “plates.”

Each plate or platen can be associated with top and bottom levels directly attached to top & bottom structure and/or an open/close mechanism. Each plate or platen can be immediately adjacent to each other in a larger array of moveable plates that are moveable between open and closed positions. Each filter cake generating module can include at least one plate (or platen) that can be positioned close to other immediately adjacent plates for defining first chambers for formation of filter cakes when the plates are in their closed position. The filter cakes can be formed by a slurry being fed into the device for passing through the filter media within the first chambers of the closed filter cake generating modules while under a pre-selected pressure and/or temperature while the plates are in their closed positions. The filter media can retain particulates within the slurry while allowing liquid of the slurry to pass through the filter media to one or more outlets as filtrate and/or one or more drains for passing through additional first chambers of other adjacent filter cake generating modules. The collected particulates can accumulate on the filter media to form the filter cake in each first chamber. The flow of the slurry through the filter cake generating modules can be generated via a pump or other type of flow control mechanism and/or slurry flow driving mechanism. The plates (or platens) of the modules can also be moveable away from each other to open the first chambers to move the modules into open positions so that filter cakes formed in the first chambers can be discharged from the filtering device and/or filtration apparatus for downstream processing.

The plates (or platens) can be structured from metal (e.g. steel, an alloy, etc.) and/or can be composed of a polymeric material or a composite material. The plates can be injection molded plates formed via an injection molding process in some embodiments, for example.

The base 3 can include a housing that can support multiple different mechanisms of the filtration apparatus 1. For example, the base 3 can support the pressurization mechanism 5 and/or the filter media actuation device 7 for adjustable positioning of filter media. The base can also support at least a portion of the feed device 9 (e.g. tubing and/or valves for feeding of slurry, washing fluid, and/or drying fluid, associated vessels for storage of the fluid(s), etc.). The base 3 can also include and/or support at least one filtering device adjustment mechanism 11 that can help actuate motion of plates for opening and closing chambers for filter media for formation and subsequent discharge of filter cakes of solid particulate materials that can be filtered from liquid of a slurry passed through the chambers for the feed device 9. In some embodiments, the filtering device adjustment mechanism 11 can be at a top area or upper region of the assembly. In other embodiments, the filtering device adjustment mechanism 11 can be at a bottom area or lower region of the assembly. In some embodiments, the filtering device adjustment mechanism 11 can be at a top area or upper region of the assembly. In other embodiments, the filtering device adjustment mechanism 11 can be at a bottom area or lower region of the assembly.

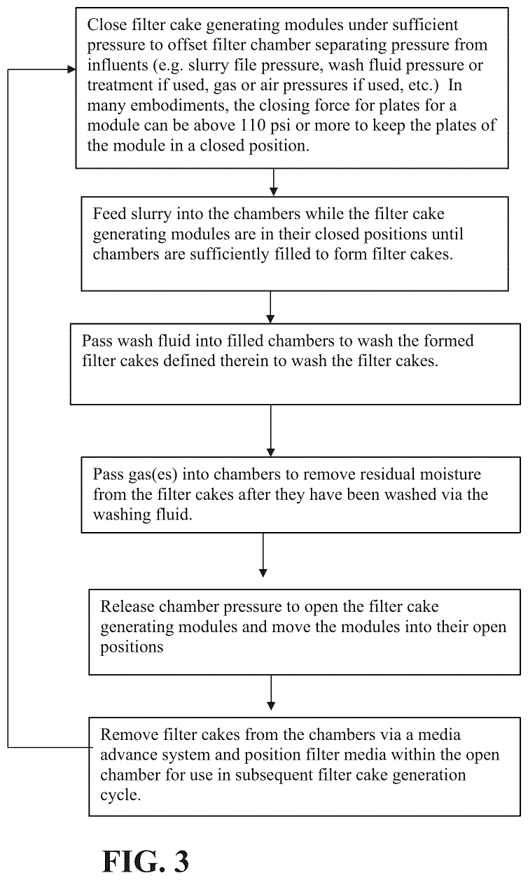

Embodiments of the filtration apparatus 1 can be utilized in exemplary methods of filtration. These methods can include, for example, the exemplary method illustrated in FIG. 3.

The filtering device adjustment mechanism 11 can help drive motion of plates that are moveable closer together to a closed position for forming first chambers defined around filter media positioned between immediately adjacent sets of plates for filtering of the solid particulate materials from the liquid of a slurry for formation of filter cakes. The filtering device adjustment mechanism 11 can also help drive motion of the plates away from each other to more spaced-out positions to open positions for opening these chambers for the discharge of the filter cakes that are formed on the filter media.

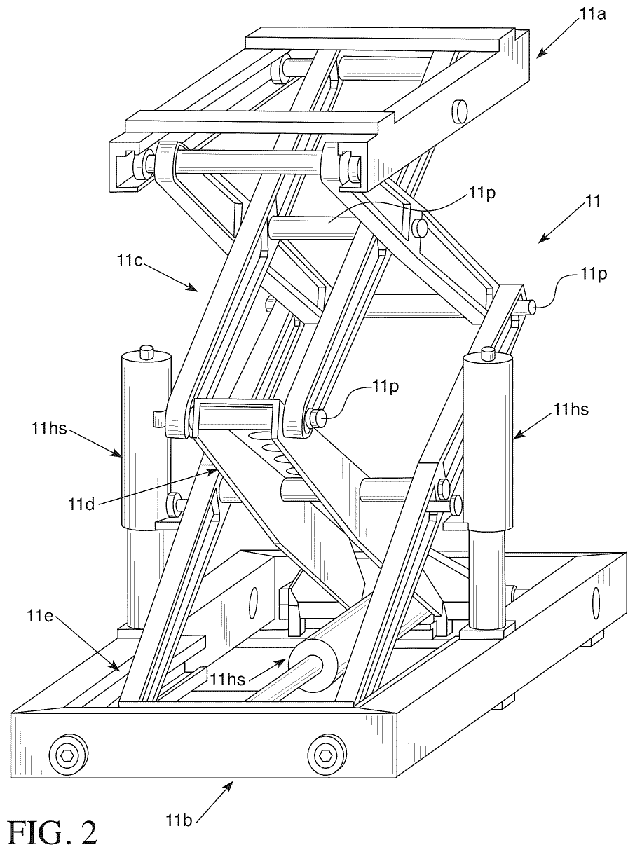

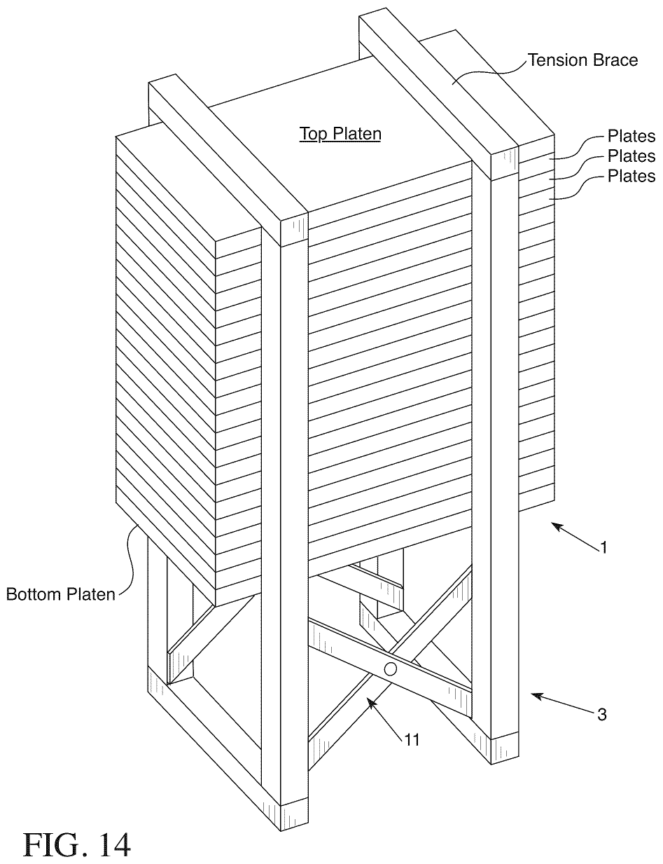

The filtering device adjustment mechanism 11 can include at least one scissor jack assembly, an example of which is illustrated in FIG. 2. It should be appreciated that other embodiments may utilize simpler scissor jack assembly configurations. For instance, the exemplary embodiment of a filtering device illustrated in FIG. 14 can utilize a simpler scissor jack assembly for its filtering device adjustment mechanism 11 as shown in FIG. 14. The embodiment shown in FIG. 1 can utilize this simpler scissor jack assembly or a more complicated configuration as shown in the exemplary embodiment of FIG. 2. In other embodiments, the filtering adjustment mechanism can include one or more hydraulic cylinders, one or more linear actuator or an array of linear actuators. Other examples of the filtering adjustment mechanism can include pneumatic jacks, electric jacks, or other type of adjustment actuation mechanism. The actuators or scissor jack of the filtering device adjustment mechanism 11 can be arranged at a location above the plates (e.g. above a top platen) or at a bottom of the plates (e.g. below the bottom platen) for actuation to adjust the position of the filtering device between open and closed positions.

The exemplary filtering device adjustment mechanism 11 shown in FIG. 2 as a scissor jack assembly includes one or more hydraulic cylinders 11hs that are positioned so that extension of one or more of the cylinders 11hs causes the assembly to extend to a taller height or longer length. Retraction of the one or more cylinders 11hs can cause the filtering device adjustment mechanism 11 to shorten to a shorter length, or shorter height. The assembly can include a bottom support 11b and a top support 11a. One of these supports can be adapted for attachment to a plate assembly for supporting and driving motion of the plates between their open and closed positions. The other of these supports can be adapted for attachment to a portion of the base 3 so the base 3 can support the assembly of plates. For example, the top support 11a can be attached to the plate assembly and the bottom support 11b can be connected to lower frame portion of the housing of the base 3. As another example, the bottom support 11b can be attached to the plate assembly and the top support can be coupled to an upper portion of the frame of the housing of the base 3 so the base supports the filtering device adjustment mechanism 11.

The body of the filtering device adjustment mechanism 11 can include a number of arms that are pivotally attached together via a series of pivotal attachments 11p (e.g. pivot pins or other types of axles) so that the motion of the adjustment mechanism between fully extended and fully retraced positions driven by the one or more hydraulic cylinders occurs via motion of the arms rotating about the different axles or pivot pins. For instance, there can be upper arms 11c pivotally connected to each other that extend between the top support 11a and an intermediate set of arms 11d. The intermediate set of arms can be pivotally attached via pivotal attachments 11p to the upper arms 11c and lower arms 11e. The lower arms 11e can be pivotally attached to the intermediate arms 11d and extend to pivotal attachments at the bottom support 11b to which the lower portion of the lower arms 11e are pivotally attached via pivotal attachment(s) 11p.

Pivotal motion of the different sets of arms driven by one or more hydraulic cylinders can allow the assembly of plates to be moved more quickly while also allowing the base to be more compact in size while also providing an extended range of sizing between the length of the filtering device adjustment mechanism 11 when it is at its shortest position (which can coincide with the closed position for the plates or the open position for the plates) and its longest portion (coinciding with the opposite of the position of the plates when the mechanism 11 is at its shortest position, i.e. open position for the plates when the shortest position defines the closed position or closed position for the plates when the shortest position defines the open position for the plates).

The operation and arrangement of filter cake generating modules of the filtering device of the filtration apparatus 1 when performing the exemplary method of FIG. 3 may best be appreciated from FIGS. 1 and 4-16.

For instance, the plate assembly, or platen assembly, can include a number of filter cake generating modules. Each module can include at least one platen or plate. In some embodiments, the assembly can include a number of filter cake modules positioned between a top platen or plate and a bottom platen or plate. The top platen, or plate, may include an inlet for receiving slurry and a plurality of lower openings for slurry to pass downwardly onto lower filter cake generating module platens. The bottom platen, or plate, can only have an outlet so that filtrate can be output from the bottom platen after the slurry has passed through filter media positioned within chambers of the upper filter cake generating modules positioned above the bottom platen and between the bottom and top platens.

Each inlet can be a conduit that is connected to a sidewall of a platen or plate. The connection can utilize one or more O-rings, or may utilize a threaded connection, elastomeric insert, or other type of inlet conduit connection mechanism.

Each outlet can be a conduit that is connected to a sidewall of a platen or plate. The connection can utilize one or more O-rings, or may utilize a threaded connection, elastomeric insert, or other type of inlet conduit connection mechanism.

Each filter cake generating module can include at least one platen or plate that has a filter media guiding pulleys positioned on opposite sides of the platen (e.g. intake or feed pulleys at a side of the platen for guiding filter media into the first chamber region and discharge pulleys at an opposite side for guiding motion of filter media for discharging filter cake material passed that side). Filter media can be positionable over the pulleys and move along those pulleys. Motion of the filter media can be driven by at least one filter media actuation device 7. Filter media positioned in a chamber of a platen or plate can be positionable therein so that it can be flexed to a bowed shape (e.g. concave shape or convex shape) for receipt and retention of particulates for filtering those solid particulates from the liquid or gas of a slurry in which the solid particulates are entrained. In some embodiments, the filter media can be filter cloth, filter webbing, or other type of filter media.

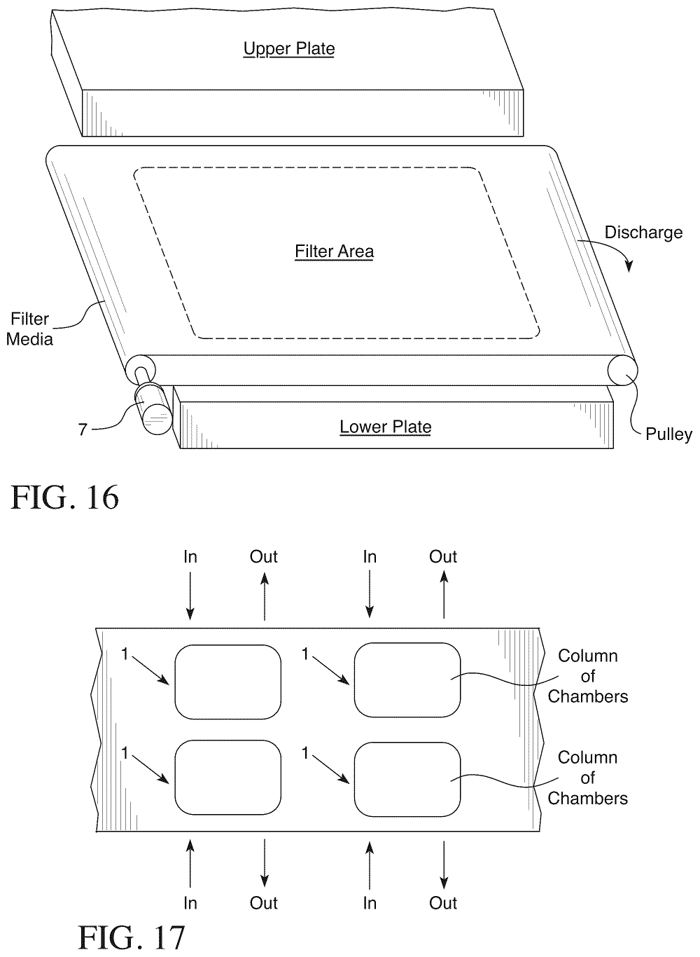

FIG. 16 illustrates an exemplary filter module having filter media positionable therein. The module can be sized and shaped to define a filter area on which a filter cake is formable via the filter media. The filter area can be defined between the discharge and feed pulleys.

The pulleys utilized for discharge and feed pulleys can be sized to meet a particular set of design criteria. For example, as indicated in FIG. 18, the pulley sizes can range from 3.5 inch (8.89 cm), 5.5 inch (13.97 cm), and 6.375 inch (16.1925 cm) pulleys. Pulleys can also include pulleys having multiple diameters (e.g. pulleys having first and second diameters as shown in FIG. 12). Other pulleys of other sizes can alternatively be utilized. The pulley sizes can be adapted to account for various design considerations including filter media type, pre-determined filter cake thickness that may be desired, and other criteria. In some embodiments, the discharge pulleys can be a different style or size of pulley than the feed pulleys.

Each filter cake generating module can also include a drainage grid positioned adjacent the filter media to guide slurry into the chamber and out of the chamber. Each filter cake module platen and the top platen can also include lower distribution holes for feeding filtrate or slurry out of the filter fake generating module toward other filter cake generating modules or the bottom platen. A distributor (e.g. distribution strap, other type of distributor) can be positioned to help drive a flow of the slurry between filter cake generating modules in a desired path for filtration of the solid particulates from the fluid of the slurry.

Each filter cake generating module and the bottom platen can include an outlet. Filtrate (e.g. fluid that has passed through filter media) can be output from the outlets. The output filtrate can be fed to a tank for recycling of the filtrate, refeeding to the filtering device of the filtration apparatus, storage, and/or another type of processing that may be downstream of the filtration apparatus. The outlets for the bottom platen and the platens of the filter cake generating modules can be positioned in a side wall of a platen along filtrate discharge sides of the platens.

Each filter generating module can also include a pan positioned in a first chamber of the module defined between discharge and feeding sidewalls of the platen. The pan can be shaped to be concave to support filter media positionable over the pan so that when slurry, washing fluid, or drying fluid is passed through the module, the filter media can be in a bowed configuration while in the first chamber for forming the filter cake. In other embodiments (e.g. embodiment of FIG. 17), the pan can be convex in orientation (e.g. be inverted as compared to the concave embodiment). The inverted pan can help adjust a defined space in which the filter cake can be formed via the filter media so that a different sized filter cake (e.g. a thicker filter cake) can be formed in the chamber when the plates are in a closed position.

While the filter cake is being formed or after the filter cake is formed, the pressure and temperature within the chamber can be adjusted. The pressure can be increased to facilitate filter cake formation and subsequent washing, for example. The temperature can be adjusted via heating elements in the filter cake generating modules or heated fluid passed into the first chambers to facilitate filter cake formation, washing, and/or drying of the filter cake material before the modules are moved to their open positions for discharging the filter cakes. In addition to washing or drying or as a type of washing or drying, a fluid can be passed through the filter cake material to treat the filter cake particulate material (e.g. remove one or more impurities, dry the material, etc.). The fluid can be heated to help facilitate drying and impurity removal, for example.

In some implementations, the washing fluid can include steam and/or hot moisture condensate that is applied under pressure to the filter cakes. The pressure can then be reduced quickly so that hot moisture (e.g. hot liquid) is released and condensate or liquid of the washing fluid changes to gas to dry the filtered particulate material of the filter cakes. In such an implementation, the washing fluid can also function as a drying fluid based on the quick adjustment of pressure. In such an implementation, there may not be a need to further pass a drying fluid through the filter cake. Alternatively, a drying fluid can also be passed through the filter cakes after the quick reduction in pressure and initial drying occurs.

The drying fluid can be a hot gas. In some implementations, the drying fluid can be hot air output from a compressor or hot air that is heated by heat of compression that is subsequently fed to the filter cakes of the filter cake generating modules. The drying fluid can also, or alternatively be other types of heated gas streams or heated process fluid streams that can be suitably fed to the filter cakes for drying the filter cakes. In some implementations, the drying fluid can be a mixture of heated process gases output from other units that is used for passing through the filter cakes for drying of the filter cakes.

The drying and/or washing of the filter cakes can also occur to facilitate removal of impurities in some implementations. Such impurity removal can be based on the content of the fluid being utilized for the drying and/or the content of fluid used for washing of the filter cakes. For instance, additives or elements at a certain concentration range can be included in a washing fluid or a drying fluid to facilitate impurity removal via adsorption and/or absorption.

After the filter cake is formed and optionally washed and dried, the platens of the modules can be moved to their open positions and the filter media can be tensioned to be more linear in orientation for moving the filter cake out of the first chamber for outputting into a discharge chute or other filter cake output conduit positioned adjacent a filter cake discharge side of each platen of each module.

Each filter cake generating module can also include a drain grid to help drive flow of the filtrate toward the outlet of the module while also passing through bottom drainage holes defined in the platen for feeding slurry to lower filter cake generating modules and/or the bottom platen.

After the slurry is passed through the filter cake generating modules for a sufficient amount of time for forming filter cakes on the filter media within the first chambers of those modules, the feed of slurry can be stopped. A washing fluid (e.g. water, a solution of water and other cleaning agents) can be passed through the top platen and filter cake generating modules to follow the same flow path as the slurry for cleaning the filter cake particulates for a pre-selecting cleaning time period to remove undesired impurities from the solid particulate material of the filter cakes. A drying operation can subsequently be performed by passing air or other type of gas flow through the filter cakes along the same flow path as used by the washing fluid and the slurry (e.g. via inlets of the filter cake generating modules and top platen and outlets of these modules and bottom platen). The drying operation can be utilized to remove moisture from the filter cake particulates. The feeding of cleaning fluid and drying fluid can occur via the same inlet used by the slurry or via at least one separate feeding inlet for the filter cake generating modules and top platen.

After drying, the platens can be vertically moved away from each other via actuation of the filtering device adjustment mechanism 11 so that the filtering device is adjusted from its closed position to its open position. Once in the open position, the filter media can be adjustably moved for discharge of the filter cake as discussed above. Thereafter, the filtering device adjustment mechanism 11 can be actuated to move the platens of the filter cake generating modules close together into the closed position of the filtering device. Thereafter, the filtering cycle can be repeated (e.g. feeding of slurry and subsequent optional washing and/or drying of the filter cake for subsequent opening of the filtering device for discharge of the formed filter cakes). This filtering cycle can be configured to occur every 1-2 minutes. For instance, the filtering cycle can have a cycle time of less than 2 minutes and greater than 0 seconds, less than 1 minute and greater than 0 seconds, less than 30 seconds and greater than 0 seconds, or less than 10 seconds and greater than 0 seconds, within a 1-18 second range, etc.).

When the filtering device is in the closed position, the plates of each filter cake generating module can be positioned in close proximity so that each plate contacts immediately adjacent plates. The chambers of the plates can be in fluid communication with each other via at least bottom drainage openings in the top platen and platens of the filter cake generating modules as well. A compressor or pump can be positioned to pressurize the flow of fluid for driving the slurry, washing fluid and/or drying fluid into the chambers of the platens when in their closed position.

The filtering device adjustment mechanism 11 can be coupled to the plates to drive motion of the plates. In some embodiments, each platen can have slots to define a path of travel of the platen between its open and closed position. A locating pin can be positioned in each slot. Motion of the filtering device adjustment mechanism 11 between extended and retracted positions can cause the locating pin to move between an upper part of the guide slot and a lower part of the guide slot. The locating pins can extend from a rack attached to the base 3 to help support motion of the plates and guide their motion for adjustment of the filtering device between its open position and closed position.

The configuration of the plates can be adapted to meet a particular set of design criteria. For instance, chambers for the plates can be sized to be a depth of ⅝″ (0.625 inches or 1.5875 cm) to 1.75 inches (4.445 cm) deep, which can facilitate formation of filter cakes that are less than 0.125 inches (0.3175 cm) thick to 1.5 inches (3.81 cm) thick in some embodiments. The rate of filter cake formation can be sufficiently quicker than conventional devices as well to provide enhanced filtration operation so that more solids are filtered at a substantially quicker period of time.

The configuration of the pans and drainage grids as well as other components (e.g. slurry distributor, etc.) can also be adjusted to meet a particular set of design criteria. In some embodiments, the filtered solids are defined in the filter media above the bottom of each plate chamber, as they are on the filter media. This can avoid solids accumulating below the plate mating area, which can eliminate filter media damage.

Embodiments can be configured to require use of substantially less drying fluid and/or washing fluid to provide improved performance as compared to conventional devices. Less fluid can be required for quicker operation, to provide a more cost-effective operation that provides improved yield, for example.

It should be appreciated that the material composition of the plates, pans, drainage grids, and outlets can be any of a number of suitable materials (e.g. carbon steel, stainless steel, polymeric material, poured or cast material, cast iron, cast steel, or cast stainless steel structures, etc.). The particular structure and composition of the drainage grid can be adjusted for a particular application to account for filter cake thickness design criteria and filter media type.

The type of filter media that is utilized can also be adjusted to meet a particular set of design criteria. For example, the filter media can include cloth material, polymeric material, elastomeric material, composite material, metallic material, ceramic material, other material and combinations thereof.

Embodiments of the filtering device can also be arranged to include multiple rows and columns of filter cake generating modules that can be moved between open and closed positions for formation of filter cakes and discharging of the filter cakes having the filtered particulate material. All such rows and columns of the filter cake generating modules can be positioned and housed within a single base or housing or there can be four different devices arranged next to each other to define such a row of columns and rows. FIG. 19 illustrates one exemplary arrangement of such a filtering device.

It should also be understood that the foregoing is provided for illustrative and exemplary purposes; the present invention is not necessarily limited thereto. Rather, those skilled in the art will appreciate that various modifications, as well as adaptations to particular circumstances, are possible within the scope of the invention as herein shown and described. For instance, different embodiments may be designed to meet a particular set of design criteria. As another example, the size and configuration of different elements and the material for those elements can be designed for a particular operational objective (e.g. filtration of a particular type of mineral from a liquid slurry, filtration of a particular set of solid particulates from a slurry, a size and layout of the facility in which at least one filtration device is to be incorporated, operational parameters at which the facility that will include one or more filtration devices is to operate, etc.).

As yet another example, it should be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement. Therefore, while certain exemplary embodiments of filter devices, filtration apparatuses used to remove solid particulates from a slurry, and methods of making and using the same have been shown and described above, it is to be distinctly understood that the invention is not limited thereto but may be otherwise variously embodied and practiced within the scope of the following claims.

1. A filtration apparatus comprising:
a base;
a filtering device supported by the base, the filtering device being adjustable between an open position and a closed position, the filtering device having a plurality of filter cake generating modules, each of the filter cake generating modules comprising at least one moveable plate, the moveable plates of the filter cake generating modules being moveable to be spaced apart from each other when the filtering device is in the open position and also being moveable to be positioned so that each of the plates is positioned adjacent to or in contact with at least one immediately adjacent other plate of another one of the filter cake generating modules when the filtering device is in the closed position, each of the filter cake generating modules having a first chamber when the filtering device is in the closed position;
a plurality of filter media, each of the filter media being positionable in a respective one of the first chambers to separate solid particulates of a slurry from a fluid of the slurry to form a filter cake; and
a filter device adjustment mechanism positioned to drive motion of the filter cake generating modules so the plates of the filter cake generating modules move away from each other to be spaced apart from each other when the filtering device is in the open position and also drive motion of the filter cake generating modules so the plates of the filter cake generating modules moved to be positioned adjacent to immediately adjacent ones of the plates of the filter cake generating modules when the filtering device is in the closed position.

2. The filtering apparatus of claim 1, wherein the filter device adjustment mechanism comprises at least one scissor jack.

3. The filtering apparatus of claim 1, wherein the filter device adjustment mechanism comprises at least one hydraulic cylinder, at least one pneumatic jack, at least one electric jack, at least one linear actuator, or an array of linear actuators.

4. The filtering apparatus of claim 1, comprising:
a feed device positioned to feed slurry into the first chambers of the filter cake generating modules while the filtering device is in the closed position.

5. The filtering apparatus of claim 1, wherein the feed device is also configured to pass a drying fluid and/or a washing fluid into the filter cake generating modules while the filtering device is in the closed position.

6. The filtering apparatus of claim 1, comprising:
a plurality of intake pulleys and a plurality of discharge pulleys, a respective one of the intake pulleys positioned adjacent a first side of the plate of a respective one of the filter cake generating modules and a respective one of the discharge pulleys positioned adjacent a second side of the plate of the respective one of the filter cake generating modules adjacent a second side of the plate that is opposite the first side of the plate, the filter media being positionable in the respective one of the first chambers extending between the intake pulley and the discharge pulley.

7. The filtering apparatus of claim 6, comprising:
a filter media actuation device configured to move the plurality of filter media along the intake pulleys and the discharge pulleys to move the filter media to transport solid particulates of a filter cake formed on the filter media to a discharge conduit positioned adjacent to the discharge pulley adjacent to the second sides of the moveable plates of the filter cake generating modules when the filtering device is in the open position.

8. The filtering apparatus of claim 6 wherein the filter media is comprised of a cloth material, polymeric material, elastomeric material, composite material, metallic material, ceramic material, other material and combinations thereof.

9. The filtering apparatus of claim 8 wherein each of the filter cake generating modules comprises a pan positioned to support the media positionable within the first chamber, the pan being convex to facilitate the filter media bowing or flexing when slurry is passed through the filter cake generating module and the filter media filters solid particulates from fluid of the slurry so the solid particulates accumulate on the filter media to form a filter cake.

10. The filtering apparatus of claim 1, wherein each of the filter cake generating modules includes a drainage grid and/or a distributor to facilitate the flow and distribution of slurry passed through the filter cake generating modules.

11. A method of filtering particulate material from a slurry, comprising:
adjusting a filtering device of a filtering apparatus to move the filtering device to a closed position to close filter cake generating modules under sufficient pressure to offset filter chamber separating pressure from at least one influent fed into first chambers of the filter cake generating modules, the at least one influent comprising a slurry;
feeding the slurry into the first chambers while the filter cake generating modules are in their closed positions until the first chambers are filled to form filter cakes therein;
passing washing fluid into the filled first chambers to wash the formed filter cakes within the first chambers;
passing at least one gas into the first chambers to remove residual moisture from the filter cakes after the passing of the washing fluid into the filled first chambers to remove residual moisture from the filter cakes after they have been washed;
adjusting the filter device to an open position to open the first chambers of the filter cake generating modules;
removing the filter cakes from the filter cake generating modules via a media advance system and positioning filter media within the first chamber of the filter cake generating modules while the filtering device is in the open position for use in a subsequent filter cake generation cycle.

12. The method of claim 11, wherein the filtering apparatus is the filtering apparatus of claim 1.

13. The method of claim 11, comprising:
passing the slurry along distributors of the filter cake generating modules while the feeding the slurry into the first chambers occurs.

14. The method of claim 11, comprising:
bowing or flexing filter media within the first chambers while the feeding of the slurry into the first chambers occurs while the filter cake generating modules are in their closed positions to form filter cakes on the filter media.

15. The method of claim 14, wherein the removing the filter cakes from the filter cake generating modules via a media advance system and positioning filter media within the first chamber of the filter cake generating modules while the filtering device is in the open position for use in a subsequent filter cake generation cycle comprises:
moving the filter media along discharge pulleys positioned on second sides of the filter cake generating modules and intake pulleys positioned on first sides of the filter cake generating modules that are opposite the second sides via the media advance system.

16. The method of claim 15, wherein the media advance system comprises a filter media actuation device.

17. The method of claim 11, wherein the washing fluid comprises at least one liquid.

18. The method of claim 11, comprising:
passing the slurry through distributor holes of plates of the filter cake generating modules while the feeding the slurry into the first chambers occurs.

19. The method of claim 11, wherein the adjusting of the filtering device of the filtering apparatus to move the filtering device to the closed position to close filter cake generating modules, the feeding of the slurry into the first chambers while the filter cake generating modules are in their closed positions until the first chambers are filled to form filter cakes therein; the passing of the washing fluid into the filled first chambers to wash the formed filter cakes within the first chambers, the passing of the at least one gas into the first chambers to remove residual moisture from the filter cakes after the passing of the washing fluid into the filled first chambers to remove residual moisture from the filter cakes after they have been washed, the adjusting the filter device to an open position to open the first chambers of the filter cake generating modules; and the removing of the filter cakes from the filter cake generating modules via the media advance system and positioning filter media within the first chamber of the filter cake generating modules while the filtering device is in the open position for use in a subsequent filter cake generation cycle; is performed in a filter cake generation cycle,
The filter cake generation cycle being performed in pre-selected period of time that is less than 3 minutes and greater than 0 seconds, less than 1 minute and greater than 0 seconds, less than 30 seconds and greater than 0 seconds, or less than 10 seconds and greater than 0 seconds.

20. The method of claim 19, wherein the pre-selected period of time is less than 1 minute and greater than 0 seconds.
